(19) United States
(12) Patent Application Publication
(10) Pub. No.: US 2015/0232201 A1
(43) Pub. Date: Aug. 20, 2015

(54) SYSTEM FOR MONITORING THE DISPERSAL OF FLUIDS AND OPERATOR PERFORMANCE

(71) Applicant: GLOBAL GROUND SUPPORT, LLC, Olathe, KS (US)

(72) Inventor: Jeffrey Walsh, Shawnee, KS (US)

(21) Appl. No.: 14/616,280

(22) Filed: Feb. 6, 2015

Related U.S. Application Data
(60) Provisional application No. 61/936,505, filed on Feb. 6, 2014.

(51) Int. Cl. B64F 5/00; G01F 1/00

(52) U.S. Cl. CPC B64F 5/0063; G01F 1/00

(57) ABSTRACT

A computer-enabled system is provided for monitoring the dispersal of deicing fluid from a deicing vehicle onto an aircraft's designated exterior portion by an operator. The system includes a dispensed-fluid-sensor, an aircraft database, a computer processor, and a non-transitory computer-readable storage medium storing computer-readable program code configured to calculate the surface area of the designated exterior portion based upon information retrieved from the aircraft database.

### CROSS-REFERENCE TO RELATED APPLICATIONS

The present application claims the benefit of, and claims priority from, U.S. Patent Application No. 61/936,505 for System for Monitoring the Dispersal of Fluids and Operator Performance filed on Feb. 6, 2014, which application is hereby incorporated by reference in its entirety.

### FIELD OF THE DISCLOSURE

The invention relates to a system for monitoring the dispersal of fluids and operator performance, and in particular a system for monitoring the dispersal of fluids from an aircraft support vehicle and the performance of the operator of the support vehicle. The invention also provides a method for monitoring the dispersal of fluids from an aircraft support vehicle and the performance of the operator of the support vehicle.

### BACKGROUND

Deicing vehicles and related aircraft ground support vehicles and equipment play a significant role in the efficient operation of commercial airlines. Particularly in colder climates, deicing vehicles are routinely utilized to effectuate the safe removal of snow, ice and frost from aircraft such as commercial passenger jets. Typically, these deicing vehicles disperse deicing fluid on an aircraft immediately prior to takeoff (e.g., within about 20 minutes of takeoff). The deicing of the aircraft is vital to the safety of people and property because ice on the wings, for example, can disrupt the flow of air causing decreased lift that can result in a loss of flight causing an accident.

Because deicing vehicles are complex pieces of equipment, they require extensive monitoring to ensure the proper application of deicing fluid. For example, the proper mixture of deicing fluid is important from a safety and economics standpoint. Mixing deicing fluid with too great a water content can, depending on the ambient temperature, reduce the effectiveness of the deicing fluid, thereby creating the possibility of an unsafe condition due to the remainder of ice buildup even after the application of deicing fluid. For this reason, government regulations and guidelines such as US DOT FAA N 8900.196 require the proper blend for deicing fluid based upon the temperature during application. From an economics perspective, certain of the constituent chemicals used in the mixture of deicing fluids (e.g., ethylene, propylene glycol, etc.) are expensive. To achieve maximum efficiency in the most cost-effective manner, it is important to use no more of these chemicals than is necessary to safely complete a deicing job. In addition, because certain of these constituent chemicals may be harmful to the environment (e.g., by contaminating ground water), minimizing their use in deicing jobs affords environmental benefits and assists with compliance with any applicable environmental regulations.

Proper mixture and application of deicing fluids requires constant, real-time monitoring of the deicing vehicle and the operator charged with applying the deicing fluid to the aircraft. Typically, a significant percentage (e.g., between about 10% and about 15%) of operators will employ improper techniques in applying the deicing fluid. For example, they may use more deicing fluid than is required to complete a deicing job, thereby resulting in wasted deicing fluid. In the long run, and especially at the busiest airports, this can result in tremendous financial losses to the ground support entity. To reduce such losses, and to ensure compliance with proper procedures, the performance of these operators is frequently monitored. Traditional monitoring techniques have not achieved meaningful comparisons between operators, however. For example, one traditional technique is to compare the time an operator takes to deice an aircraft. Because aircraft may vary greatly in size, this results in comparisons with very little real world value.

A need therefore exists for a system for monitoring the dispersal of deicing fluid from a deicing vehicle onto an aircraft. In particular, a need exists for a system that standardizes the evaluation of the performance of operators who apply the deicing fluid to the aircraft.

### SUMMARY OF THE INVENTION

The present disclosure embraces a computer-enabled system for monitoring the dispersal of deicing fluid from a deicing vehicle onto an aircraft's designated exterior portion by an operator. The computer-enabled system includes a dispensed-fluid-sensor. The dispensed-fluid-sensor measures the volume of deicing fluid dispensed from the deicing vehicle onto the designated exterior portion by the operator. The designated exterior portion includes at least one aircraft section. The computer-implemented system also includes an aircraft database for storing the surface area of each aircraft section associated with the aircraft. The computer-enabled system also includes a computer processor. The computer processor is in electronic communication with the dispensed-fluid-sensor and the aircraft database. The computer-enabled system also includes a non-transitory computer-readable storage medium. The non-transitory computer-readable storage medium stores computer-readable program code. When executed by the computer processor, the computer-readable program code (i) receives from the dispensed-fluid-sensor the volume of dispensed deicing fluid, (ii) retrieves from the aircraft database the surface area of each aircraft section included in the designated exterior portion, (iii) calculates the surface area of the designated exterior portion based upon the surface area of each aircraft section included in the designated exterior portion, and (iv) determines an operator-efficiency-rating based at least in part on the ratio of the volume of dispensed deicing fluid to the surface area of the designated exterior portion.

In one embodiment, the computer-enabled system includes an input device in electronic communication with the computer processor. The input device receives input from a user. When executed by the computer processor, the computer-readable program code receives from the input device a user's designation of the aircraft sections included in the designated exterior portion.

In another embodiment, when executed by the computer processor, the computer-readable program code receives from the input device a user's identification of the operator who dispersed the deicing fluid onto the designated exterior portion, and associates the operator with the operator-efficiency-rating.

In yet another embodiment, the deicing fluid comprises a deicing component and an anti-icing component.

In yet another embodiment, the aircraft database stores the surface area of each of the following aircraft sections: a left wing portion and a right wing portion.

In yet another embodiment, the aircraft database stores the surface area of each of the following aircraft sections: a left horizontal stabilizer portion and a right horizontal stabilizer portion.

In yet another embodiment, the aircraft database stores the surface area of each of the following aircraft sections: a left fuselage side portion and a right fuselage side portion.

In another aspect, the present disclosure embraces a computer-enabled method for monitoring the dispersal of deicing fluid from a deicing vehicle onto an aircraft's designated exterior portion. The computer-enabled method includes measuring with a dispensed-fluid-sensor the volume of deicing fluid dispensed from the deicing vehicle onto the designated exterior portion by the operator. The designated exterior portion includes at least one aircraft section. The computer-enabled method also includes retrieving from an aircraft database the surface area of each aircraft section included in the designated exterior portion. The aircraft database stores the surface area of each aircraft section associated with the aircraft. The computer-enabled method also includes calculating using a computer processor the surface area of the designated exterior portion based upon the surface area of each aircraft section included in the designated exterior portion. The computer-enabled method also includes determining an operator-efficiency-rating based at least in part on the ratio of the volume of dispensed deicing fluid to the surface area of the designated exterior portion.

In another aspect, the present disclosure embraces a non-transitory computer-readable storage medium storing computer-readable program code. When executed by a computer processor, the computer-readable program code (i) receives from a dispensed-fluid-sensor the volume of deicing fluid dispensed from a deicing vehicle onto an aircraft's designated exterior portion by an operator, (ii) retrieves from an aircraft database the surface area of each aircraft section included in the designated exterior portion, wherein the aircraft database stores the surface area of each aircraft section associated with the aircraft, (iii) calculates the surface area of the designated exterior portion based upon the surface area of each aircraft section included in the designated exterior portion, and (iv) determines an operator-efficiency-rating based at least in part on the ratio of the volume of dispensed deicing fluid to the surface area of the designated exterior portion.

### BRIEF DESCRIPTION OF THE DRAWINGS

FIG. 1 is a block diagram of an exemplary computer-enabled system according to the present disclosure.

FIG. 2 is a table representing an exemplary aircraft database of the computer-enabled system according to the present disclosure.

FIG. 3 is an alternative embodiment of an exemplary computer-enabled system according to the present disclosure.

FIG. 4 is an illustrative graphical user interface of an exemplary computer-enabled system according to the present disclosure.

FIG. 5 is an illustrative graphical user interface of an exemplary computer-enabled system according to the present disclosure.

FIG. 6 is an illustrative graphical user interface of an exemplary computer-enabled system according to the present disclosure.

FIG. 7 is an illustrative graphical user interface of an exemplary computer-enabled system according to the present disclosure.

FIG. 8 is an illustrative graphical user interface of an exemplary computer-enabled system according to the present disclosure.

FIG. 9 is an illustrative graphical user interface of an exemplary computer-enabled system according to the present disclosure.

FIG. 10 is an illustrative graphical user interface of an exemplary computer-enabled system according to the present disclosure.

### DETAILED DESCRIPTION

The present invention will now be described more fully hereinafter with reference to the accompanying drawings. This disclosure may, however, be embodied in many different forms and should not be construed as limited to the embodiments set forth herein. Rather, these embodiments are provided so that this disclosure will be thorough and complete, and will fully convey the scope of the invention to those skilled in the art.

The computer-enabled system of the present disclosure is configured for monitoring the dispersal of deicing fluid from a deicing vehicle onto an aircraft's designated exterior portion by an operator. As used in this disclosure, the term deicing fluid is intended generally to include all fluids or other materials that may be applied to an aircraft for the purpose of removing ice (e.g., snow, frost, sleet, freezing rain or other forms of ice) or preventing the formation of ice on the aircraft. As will be discussed below, deicing fluid may include separate constituent components, each of which may be applied at different times and for different purposes relating to the process of deicing an aircraft.

As used in this disclosure, the term deicing vehicle is intended generally to mean any vehicle, machine, or apparatus configured for applying deicing fluid to an aircraft. The deicing vehicle is typically mobile such that it can travel to different parts of an airport to service aircraft at different locations (e.g., at a gate, on a taxiway, etc.). Less typically, the deicing vehicle may be immobile (e.g., a deicing station).

As used in this disclosure, the term aircraft is intended broadly to mean any machine capable of flight, including an airplane (e.g., fixed-wing aircraft), helicopter, glider, drone, rocket, jet, jetliner, commercial jet, etc.

As used in this disclosure, the term operator is intended broadly to refer to a person applying deicing fluid onto an aircraft. Typically, the operator is stationed in a compartment (e.g., deicer basket) positioned at the end of a boom extending from the deicing vehicle. From there, the operator controls the flow and direction of deicing fluid being dispersed onto the aircraft. Alternatively, the operator may remotely control the dispersal of deicing fluid (e.g., through a robotic nozzle assembly). The operator may include one or more people (e.g., a deicing team). The operator may be the same person as the system user. In other words, the operator may interact with the present computer-enabled system (e.g., provide input and view output) and also disperse deicing fluid. More typically, the operator remains at the deicing fluid dispensing station while another person (e.g., the deicing vehicle driver) interacts with the present computer-enabled system.

As used in this disclosure, designated exterior portion refers to that portion of an aircraft's exterior that has been selected (e.g., designated) for treatment with deicing fluid. Typically, the decision as to which portions are to be treated is made by the pilot(s) of the aircraft. The decision is usually communicated to the deicing crew. As explained below, a system user can provide this information to the computer-enabled system. Typically, the designated exterior portion is less than the entire aircraft exterior. The designated exterior portion includes at least one aircraft section. As used herein, the term aircraft section refers to a discrete segment (e.g., subsection) of the exterior of the aircraft. Typically, an aircraft section is not arbitrarily defined, but is related to a specific structure of the aircraft. For example, generally only upper (e.g., topmost) surfaces are treated with deicing fluid. For example, the top of each wing and the top of each half (left/right) of the horizontal stabilizer are usually targets for deicing because these are surfaces directly related to generating lift and stability, and because ice tends to collect most heavily on these surfaces. Each side of the fuselage may also be a target for receiving deicing treatment. Consequently, examples of aircraft sections include a left wing portion (e.g, the top surface of the left wing), a right wing portion, a left horizontal stabilizer portion, a right horizontal stabilizer portion, a left fuselage side portion, and a right fuselage side portion. There may be other or different aircraft sections, each of which may be defined within and recognized by the present computer-enabled system. As an illustrative example, if the deicing job were directed at treating only the wings, then the designated exterior portion would include the aircraft sections of the left wing portion and the right wing portion; but the designated exterior portion would not include, for example, the left horizontal stabilizer portion because that aircraft segment is not assigned to receive treatment with deicing fluid.

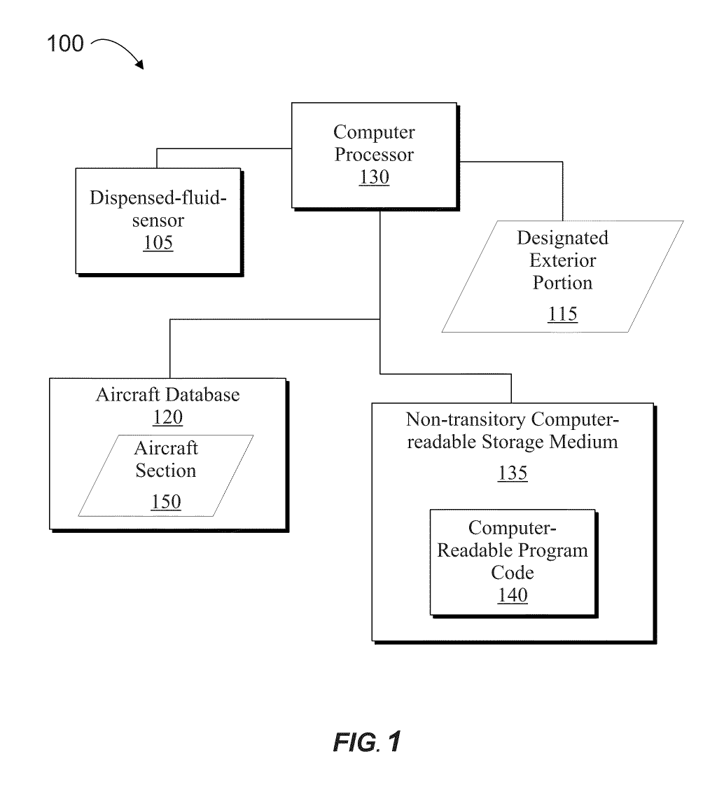

Reference is now made to FIG. 1. The computer-enabled system 100 includes a dispensed-fluid-sensor 105. The dispensed-fluid-sensor 105 is configured for measuring the volume of deicing fluid dispensed from the deicing vehicle onto the aircraft's designated exterior portion by the operator. The dispensed-fluid-sensor 105 may be any type of sensor, or collection of sensors, suitable for measuring the volume of deicing fluid dispensed from the deicing vehicle. The dispensed-fluid-sensor 105 may be a mechanical sensor, and electronic sensor, or a combination electronic and mechanical sensor. The dispensed-fluid-sensor 105 may measure the volume of deicing fluid dispensed from the deicing vehicle directly, or indirectly by measuring the decrease in volume of deicing fluid in the deicing fluid storage tank. Typically, the dispensed-fluid-sensor includes a turbine flow meter (e.g. axial turbine). The turbine flow meter is typically positioned within the hose that is connected to the storage tank and that is used to dispense the deicing fluid from the storage tank. The flow of deicing fluid through the hose turns the turbine portion of the turbine flow meter. The rotation rate of the turbine portion is translated into a rate of flow (e.g., gallons per minute, liters per minute, etc.), which can, in turn, be converted into a volume based upon the duration of time that the deicing fluid is flowing through the hose.

The dispensed-fluid-sensor 105 may be configured to measure the volume of multiple types of deicing fluid because, in some instances, deicing fluid includes a deicing component and a separate anti-icing component. Typically, the deicing vehicle is fitted with at least two storage tanks. A first storage tank contains the deicing component, which is a fluid designed to remove frost, snow and ice from the aircraft (e.g., by melting). Typically, this deicing component (e.g., Type I deicer fluid) is heated to a high temperature prior to dispersing onto the aircraft. The deicing vehicle typically also has a second storage tank containing an anti-icing component (e.g., Type IV deicer fluid). Typically, the anti-icing component is applied after the deicing component to prevent buildup of ice on the aircraft. In instances such as this, the dispensed-fluid-sensor 105 is typically configured to obtain measurements of both the volume of the deicing component dispersed onto the aircraft and the volume of the anti-icing component dispersed onto the aircraft.

It will be appreciated that the measurement of the volume of deicing fluid dispensed from the deicing vehicle is not strictly limited to deicing fluid that actually is dispersed onto the designated exterior portion. Some amount of deicing fluid will not reach the designated exterior portion, for example to due to fluid leaks and spillage, drift due to wind, or the inherent imprecision of the deicing process. Instead, the present computer-readable system measures the volume of deicing fluid used during the process of deicing the designated exterior portion, whether or not the dispersed deicing fluid in fact reached the designated exterior portion. For example, if an operator misdirects the dispersal of deicing fluid onto the ground during the deicing process, the volume of the misdirected deicing fluid would typically be included in the volume of deicing fluid measured by the dispensed-fluid-sensor. This is beneficial in that the present computer-enabled system 100 accounts for wasted deicing fluid, thereby potentially prompting corrective action to reduce or eliminate the waste of deicing fluid (e.g., by repairing leaks, improving dispersal techniques, etc.).

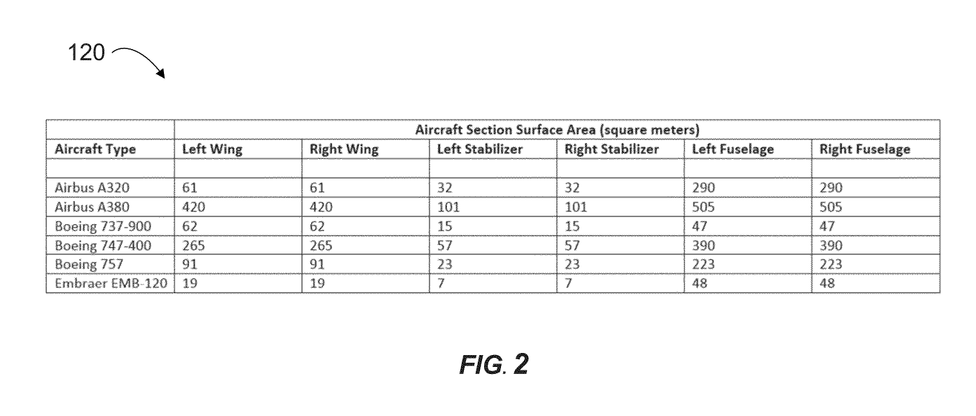

The computer-enabled system also includes an aircraft database 120. The aircraft database 120 is configured for storing the surface area (e.g., the measurement of the surface area) of each aircraft section associated with the aircraft. An exemplary record in the database 120 may include the type of aircraft as well as the surface area corresponding to that type of aircraft's left wing portion, right wing portion, etc. An exemplary representation of an aircraft database 120 appears at FIG. 2. The leftmost field of this exemplary aircraft database 120 represents the type of aircraft (e.g., manufacturer's model number) and the remaining fields correspond to the surface area (for this example provided in square feet) associated with each aircraft section 150.

The database 120 may be of any suitable type and form of data storage structure, including a relational database or table. The database 120 may be stored on one or more mass storage devices (e.g., hard drives, solid state drives, etc.). In some instances, the database 120 comprises a database server. In other instances, the database 120 is a data file stored on the same computer media (e.g., hard drive) as one or more of the system computer files (e.g., executable files) that make up the software component of the computer-enabled system 100 according to the present disclosure.

The aircraft database 120 may store information associated with one or more types of aircraft. Typically, the database 120 stores information associated with a large number of aircraft types (e.g., aircraft models). More typically, the aircraft database 120 stores information associated with every type of aircraft that can or will likely be serviced by the deicing vehicle. When presented with a deicing job, a system user can therefore readily access information (e.g., surface area) related to the type of aircraft that is the subject of the deicing job. As will be appreciated by a person of ordinary skill in the art, although certain exemplary embodiments of the computer-enabled system 100 are presented from the perspective of use for a single deicing job, the present computer-enabled system 100 is configured for, and is more typically used for, monitoring a plurality of deicing jobs, some of which may be transpiring concurrently. Typically, several (e.g., between about 5 and about 20) types of aircraft are the subject of deicing jobs during the course of a single day of airport operation. Having an aircraft database 120 that is populated with information associated with a variety of aircraft types ensures that the computer-enabled system 100 can adequately monitor the dispersal of deicing fluid for each deicing job.

The computer-enabled system 100 also includes a computer processor 130. The computer processor 130 is in communication (e.g., electronic communication, data communication, etc.) with the dispensed-fluid-sensor 105 and the aircraft database 120. The communication may be direct or indirect, and may be facilitated by a computer bus, network connection (e.g., wired or wireless network connection, LAN, WLAN, PAN, RF, etc.), or any other suitable means of electronic communication (e.g., transmitting and receiving a signal). The computer processor may include a central processing unit, a memory (e.g., ROM and RAM), a communications bus, an operating system, a BIOS or any other component suitable for providing the computer processor 130 with sufficient computing capabilities to achieve the functionality required of the present computer-enabled system 100. The computer processor 130 may include a vehicle mount computer, a tablet computer, a laptop computer, a wearable computer, a desktop computer, a smartphone, or any other suitable computing device(s). In an exemplary embodiment, the computer processor 130 is mounted to, or is integral with, the deicing vehicle. For example, the computer processor 130 may be mounted in the dashboard of the deicing vehicle. Alternatively, the computer processor may be separate from the deicing vehicle, such as when the computer processor 130 includes a mobile device such as may be carried or worn by the system user.

The computer-enabled system 100 also includes a non-transitory computer-readable storage medium 135. The non-transitory computer-readable storage medium 135 is configured for storing computer-readable program code 140. Typically, the non-transitory computer-readable storage medium 135 may include a hard drive, solid state drive, flash drive (e.g., flash memory), optical disk, or similar suitable storage means. The computer-readable program code 140 may include source code and/or object code, which may be in any form (e.g., any programming language) that can be properly executed by the computer processor 130. As will be appreciated by a person of ordinary skill in the art, any aspect of the present disclosure which may be embodied in computer software may also be embodied in computer hardware, and vice-versa.

When executed by the computer processor 130 the computer-readable program code 140 receives from the dispensed-fluid-sensor 105 the volume of dispensed deicing fluid. By way of example and without intending to limit the disclosure, the computer-readable program code 140 receives a signal (e.g., electrical signal) from the dispensed-fluid-sensor 105 from which the computer-readable program 140 may determine (e.g., through reading, processing, calculating, etc.) the measurement of the volume of dispensed deicing fluid (e.g., the amount of deicing fluid dispensed by the deicing vehicle during the deicing job associated with the designated exterior portion).

The computer-readable program code 140 also retrieves from the aircraft database 120 the surface area of each aircraft section 150 included in the designated exterior portion 115. Having obtained this information from the aircraft database 120, the computer-readable program code 140 calculates the surface area of the designated exterior portion 115 based upon the surface area of each aircraft section 150 included in the designated exterior portion 115. The surface area of the designated exterior portion 115 may be calculated by adding the surface areas of the constituent aircraft section(s) 115.

By combining the information obtained via the dispensed-fluid-sensor 105 with the information retrieved from the aircraft database 120, the computer-readable program code 140 can determine the volume of deicing fluid used per unit of area (e.g., liters per square meter, gallons per square foot, etc.). Based at least in part on this ratio of the volume of dispensed deicing fluid to the surface area of the designated exterior portion 115, the computer-readable program code 140 determines an operator-efficiency-rating 142. The operator-efficiency-rating 142 is a rating (e.g., score, grade, scale, performance rating, performance level, etc.) associated with the efficiency and/or effectiveness of the performance of the deicing job. For example, the operator-efficiency-rating 142 may be selected from a scale of potential ratings, such as a good, average or poor rating. By way of further example, the operator-efficiency-rating 115 may be a numerical score. As another alternative, the operator-efficiency-rating 142 may be the same as the ratio of the volume of dispensed deicing fluid to the surface area of the designated exterior portion. The operator-efficiency-rating may be used to compare the performance of one operator to another operator, or to compare the performance of one operator to the average operator performance (e.g., the average performance at a particular facility, at a particular time, etc.). The system may account for other factors in determining an operator-efficiency-rating, including time to complete a deicing job, number of deicing jobs completed per shift, and/or the cumulative use of forced air when using forced air (e.g., with air hoses) to remove ice from an aircraft (e.g., as a pre-treatment to the application of deicing fluid).

By measuring the dispersal of deicing liquid in terms of units of volume per units of area, the computer-enabled system according to the present disclosure advantageously standardizes the evaluation of the performance of the deicing job. In this way, different operators performing different deicing jobs may be more fairly compared than traditional forms of comparison, such as comparing the volume of deicing fluid used per aircraft.

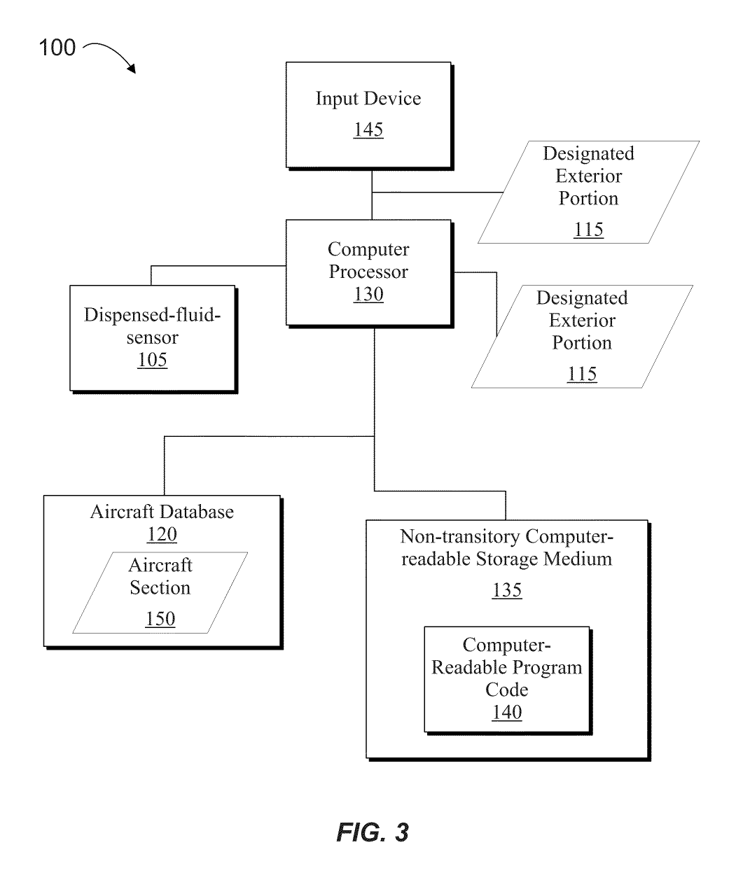

Turning now to FIG. 3, in an alternative embodiment, the computer-enabled system 100 according to the present disclosure includes an input device 145. The input device 145 is configured for receiving input from a system user (e.g., user). The input device 145 is in electronic communication with the computer processor 130. The input device 145 may be a keyboard, keypad, touchscreen, microphone, mouse, trackball, touchpad, gesture-recognition module, or any similarly suitable device for allowing a system user to input information (e.g., commands, queries, selections) into the system.

When executed by the computer processor 130, the computer-readable program code 140 receives from the input device 145 a user's designation (e.g., selection) of the aircraft section(s) included in the designated exterior portion. In this way, the user is allowed to define for the system which aircraft sections should be included in the calculation of the surface area to be treated. Allowing the user to customize the deicing job parameters in this way enhances the system's ability to accurately determine the efficiency with which deicing fluid is being dispersed during a deicing job. In addition to designating aircraft sections, a user can also indicate using the input device 145 the type of aircraft that is the subject of the deicing job. This information allows the system to accurately look up the surface are of the relevant aircraft sections from the aircraft database 120.

In another embodiment of the computer-enabled system according to the present disclosure, the computer-readable program code 140 receives from the input device 145 (e.g., via the input device) a user's identification of the operator who dispersed the deicing fluid onto the designated exterior portion 115. The computer-readable program code 140 uses this information to associate the operator with the operator-efficiency-rating 142. For example, when preparing to initiate a deicing job, a user may enter into the input device 145 the name or other identifier (e.g., employee number) of the operator who is to disperse the deicing fluid onto the designated exterior portion 115 of the aircraft. Alternatively, the user may select the operator's identifying information from a list (e.g., a menu comprising all potential operators). This enables the system to associate any relevant performance data, including an operator-efficiency-rating, to the appropriate operator.

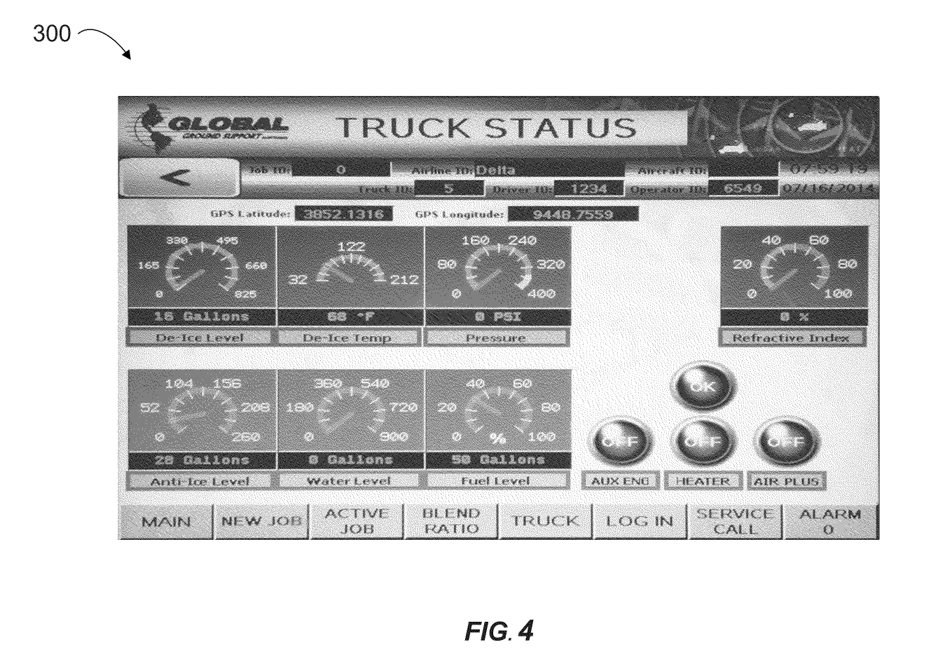

Turning now to FIGS. 4 through 10, the computer-enabled system 100 according to the present disclosure typically includes a graphical user interface (GUI) 300 for displaying information to a user via a display device such as an LCD screen, an LCD touchscreen, and the like. Additional features of various embodiments of the computer-enabled system will be described with reference to various states of the graphical user interface 300 as reflected in FIGS. 4 through 10.

Regarding FIG. 4, the system includes a truck status module for acquiring and displaying information relating to the status of the deicing vehicle. The truck status module may include acquire the location of the deicing vehicle. The location may be determined with reference to areas of a facility (e.g., at a particular gate, on a certain taxiway, at a maintenance facility, etc.). Alternatively, and as reflected in FIG. 4, the location of the deicing vehicle may be acquired through the use of a global positioning receiver. The system may correlate longitude and latitude readings to specific portions of a facility as a way of translating GPS information into facility-based information (e.g., correlate a set of GPS locations to a maintenance area), thereby “geo-fencing” certain areas of a facility. The truck status module may also acquire the volume of deicing fluid remaining in the storage tank(s) of the deicing vehicle. The temperature of the deicing fluid may be monitored, for example to ensure that the deicing component is heated to the proper temperature prior to dispersing onto an aircraft. Typically, the truck status module is in electronic communication with a temperature gauge in contact with the deicing component. The truck module may also monitor the pressure (e.g., PSI) of the deicing fluid within the storage tank(s). The level of fuel (e.g., diesel fuel) may also be monitored by the truck status module. Because the proper mixture (e.g., ratio) of glycol to water is relevant to both to the efficacy of the deicing fluid and the cost of application, the truck status may also monitor the glycol-water ratio. The truck status module may be in electronic communication with an optical refractometer configured to measure the concentration of glycol or other deicing chemical in the deicing fluid dispensed from the deicing vehicle.

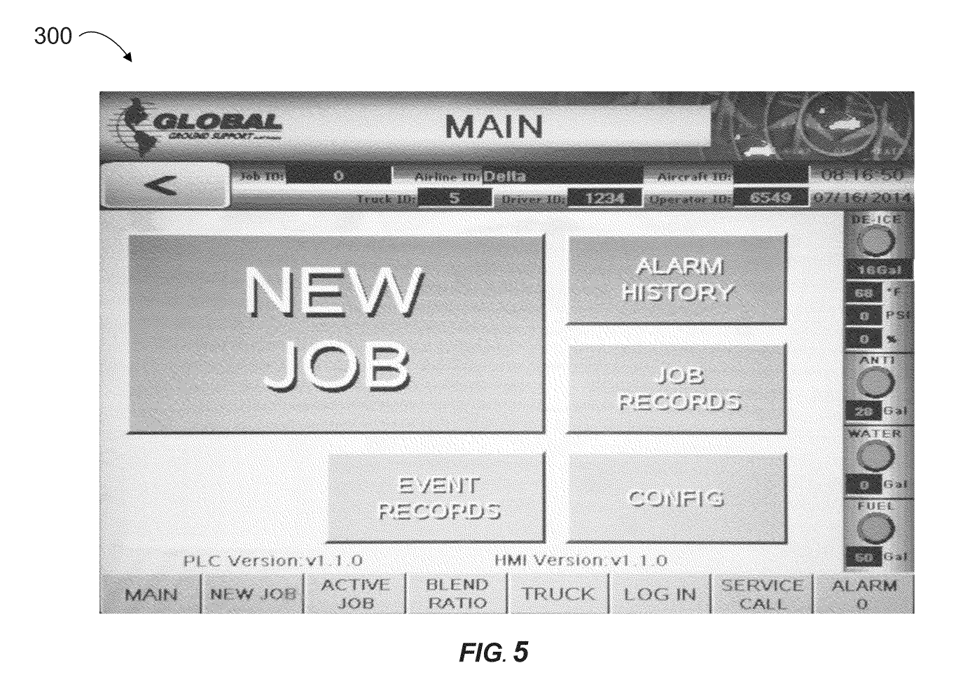

Turning now to FIG. 5, the graphical user interface 300 may be configured to display a main menu. The main menu allows the user to initiate a new job (e.g., new deicing job), view a history of alarms, view job records, view event records, and configure various aspects of the system.

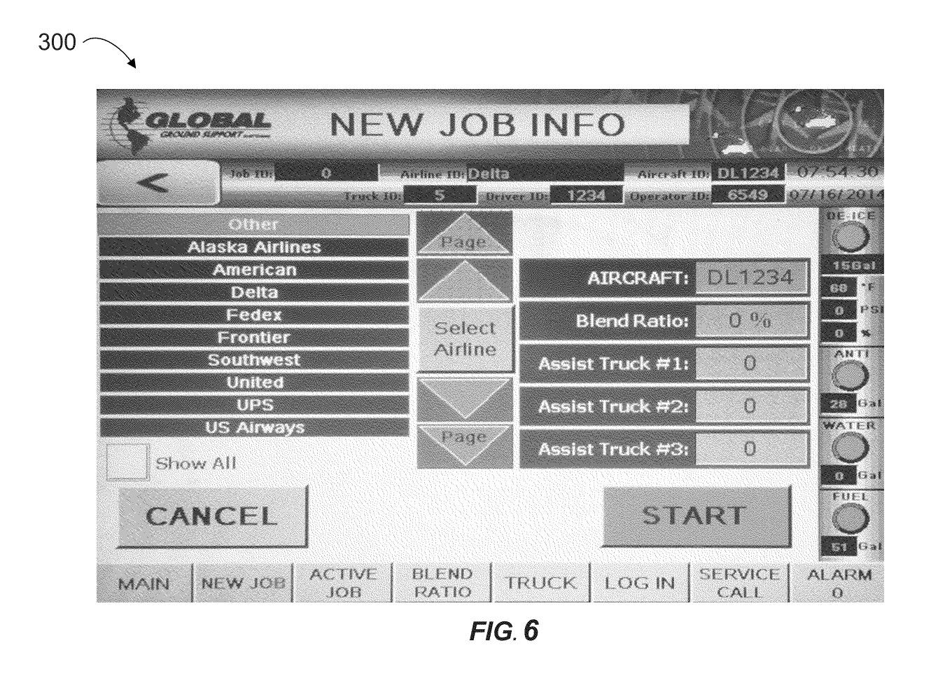

Turning now to FIG. 6, the system includes a new job module for receiving information (e.g., from a user) regarding the parameters of a deicing job. The new job module allows a user to select the airline requesting the deicing job, the specific aircraft to be deiced (e.g., identified by serial number), the deicing fluid blend ratio to be used for the job, and the identity of any other equipment (e.g., deicing vehicles) that will participate in the deicing job. The new job module is also configured to allow a user to indicate the duration of the deicing job. For example, and as illustrated by FIG. 6, the new job module may cause the display of a start button which the user selects (e.g., by clicking on it) when the deicing job begins. Similarly, the new job module can receive an indication from the user of when the deicing job ends. From this information, the new job module can calculate the total duration of the deicing job.

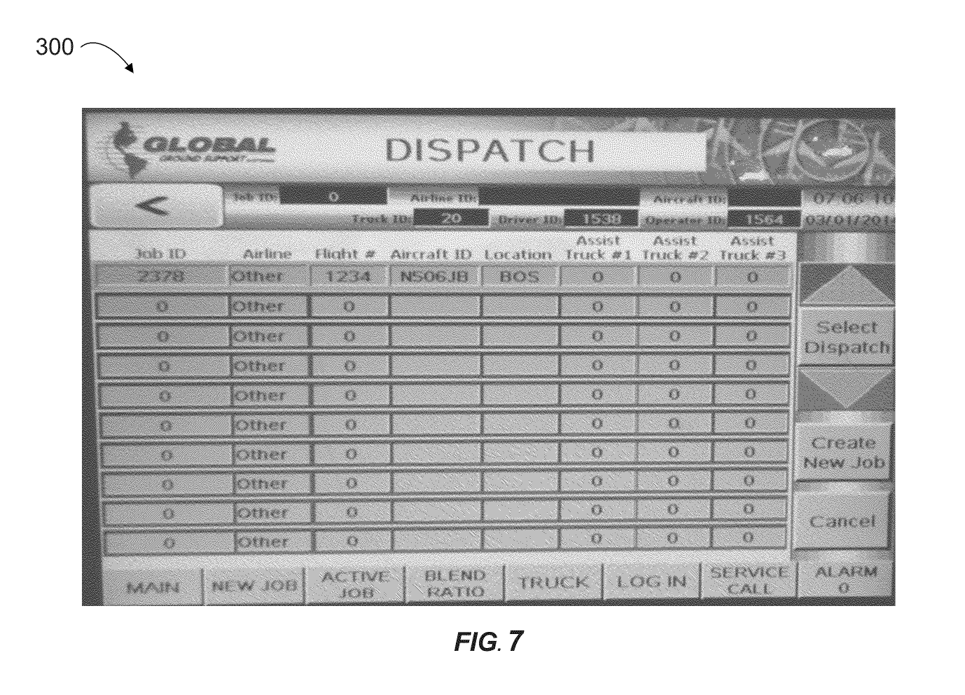

The graphical user interface 300 shown in FIG. 7 is associated with the system's dispatch module. The dispatch module allows a dispatcher to assign deicing jobs to one of a plurality of deicing vehicles. As reflected in FIG. 7, the dispatch module identifies each deicing job by a job identifier (e.g, job identification number). Each job identifier is associated with the airline, flight number, aircraft serial number, and airport location of the deicing job.

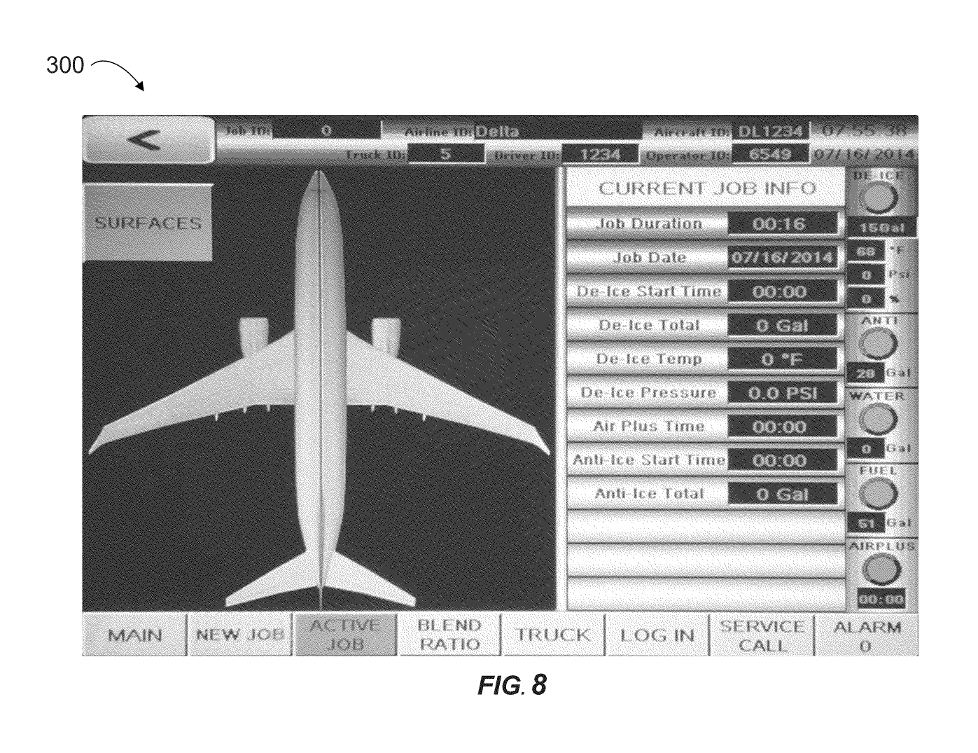

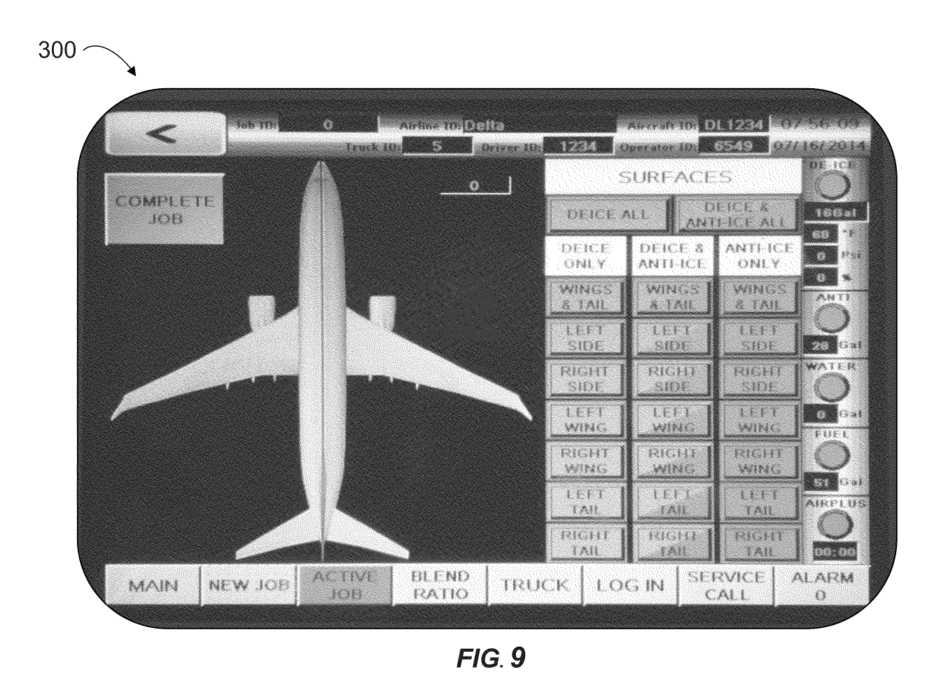

As shown in FIGS. 8 and 9, the system includes an active job module for acquiring and displaying information related to an assigned deicing job. The information acquired by the active job module includes the current or total duration of the deicing job, the date of the deicing job, the start time, the total amount of deicing fluid dispensed for the deicing job, the temperature of the deicing fluid, the pressure of the deicing fluid, the duration of application of forced air to the aircraft.

The system's monitoring of the use of forced air can be important to achieving efficiencies in the deicing process. Deicing trucks may be equipped with a forced air system that allows the operator to blow air onto an aircraft at a speed that I typically sufficient to remove significant (e.g., greater than about 30 percent) amounts of snow, ice and frost. By removing snow, ice and frost with forced air, typically less deicing fluid is required to melt the remaining snow, ice and frost. This results in costs savings and other benefits associated with less use of deicing fluid. Consequently, monitoring the use of forced air (e.g., the duration of use of forced air prior to applying deicing fluid) provides an indication of whether or not the operator is using the forced air at all and, if so, whether the operator is using the forced air for a sufficient duration to achieve the desired results. A supervisor, for example, may review this information and determine whether the operator should receiving training in the proper use of forced air.

The graphical user interface reflected in FIG. 9 allows a user to select and/or view the aircraft sections which are included in the designated exterior portion. Typically, the active job module causes the graphical user interface to display whether the individually selected aircraft sections are to receive deicing component, anti-icing component, or both.

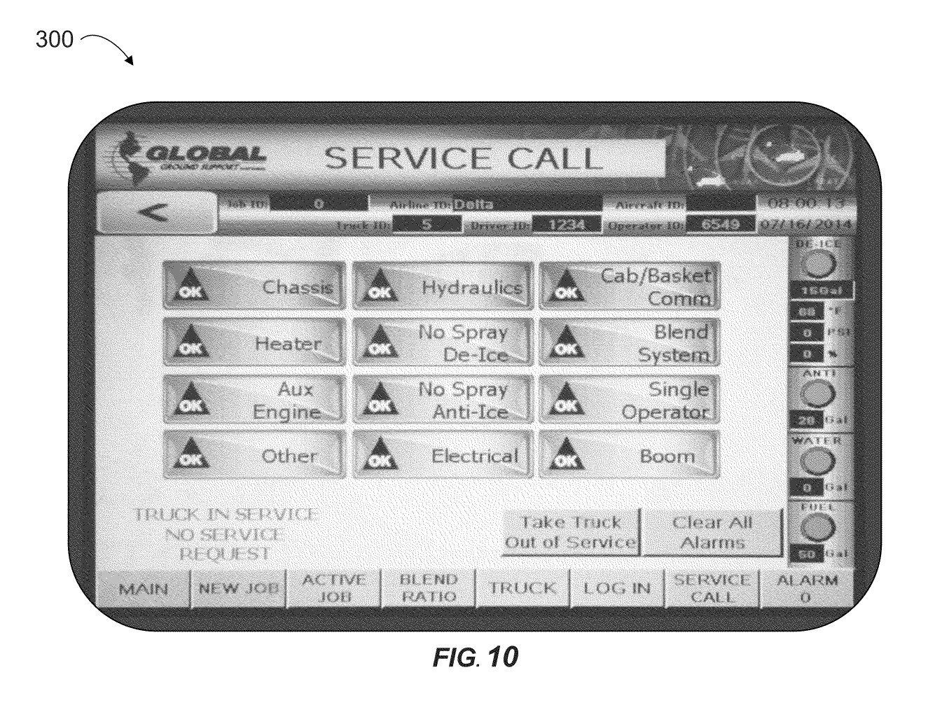

As reflected in FIG. 10, the system includes a service call module for acquiring and displaying information relating to malfunctions associated with the deicing vehicle. For example, the graphical user interface 300 associated with the service call module may display information associated with malfunctions or potential malfunctions relating to the deicing vehicle's chassis, heater, auxiliary engine, hydraulics, deicing fluid assembly, electrical system, basket, deicing fluid blend, boom, and other components. The service call module allows a user to request service (e.g., repair service) for a deicing vehicle, to view the status of the repairs to the deicing vehicle, and to indicate that the deicing vehicle is unavailable for deicing jobs due to repairs. The service call module may also indicate to the user when a requested service call has been completed.

Aspects of the computer-enabled system may be implemented using a client-server computer architecture. Furthermore, various functionalities of the system may be accessed at a plurality of workstations. For example, one workstation may be used in connection with the operation of the deicing vehicle (e.g., located in or at the deicing vehicle) and another workstation may be used in connection with the supervision of a fleet of deicing vehicles (e.g., located inside a ground operations tower).

As will be appreciated by a person of ordinary skill in the art, aspects of the present disclosure may be implemented as a computer-enabled method or as a computer-readable storage medium. Various modifications and variations may be made to the disclosed system, method, and computer-readable storage medium.

1. A computer-enabled system for monitoring the dispersal of deicing fluid from a deicing vehicle onto an aircraft's designated exterior portion by an operator the computer-enabled system comprising:
a dispensed-fluid-sensor for measuring the volume of deicing fluid dispensed from the deicing vehicle onto the designated exterior portion by the operator, wherein the designated exterior portion comprises at least one aircraft section;
an aircraft database for storing the surface area of each aircraft section associated with the aircraft;
a computer processor in electronic communication with the dispensed-fluid-sensor and the aircraft database;
a non-transitory computer-readable storage medium storing computer-readable program code, wherein, when executed by the computer processor, the computer-readable program code:
receives from the dispensed-fluid-sensor the volume of dispensed deicing fluid;
retrieves from the aircraft database the surface area of each aircraft section included in the designated exterior portion;
calculates the surface area of the designated exterior portion based upon the surface area of each aircraft section included in the designated exterior portion; and
determines an operator-efficiency-rating based at least in part on the ratio of the volume of dispensed deicing fluid to the surface area of the designated exterior portion.

2. The computer-enabled system of claim 1, comprising:
an input device for receiving input from a user, the input device in electronic communication with the computer processor;
wherein, when executed by the computer processor, the computer-readable program code:
receives from the input device a user's designation of the aircraft section(s) included in the designated exterior portion.

3. The computer-enabled system of claim 2, wherein, when executed by the computer processor, the computer-readable program code:
receives from the input device a user's identification of the operator who dispersed the deicing fluid onto the designated exterior portion;
associates the operator with the operator-efficiency-rating.

4. The computer-enabled system of claim 1, wherein the deicing fluid comprises a deicing component and an anti-icing component.

5. The computer-enabled system of claim 1, wherein the aircraft database stores the surface area of each of the following aircraft sections: a left wing portion and a right wing portion.

6. The computer-enabled system of claim 1, wherein the aircraft database stores the surface area of each of the following aircraft sections: a left horizontal stabilizer portion and a right horizontal stabilizer portion.

7. The computer-enabled system of claim 2, wherein the aircraft database stores the surface area of each of the following aircraft sections: a left fuselage side portion and a right fuselage side portion.

8. A computer-enabled method for monitoring the dispersal of deicing fluid from a deicing vehicle onto an aircraft's designated exterior portion by an operator, the method comprising:
measuring with a dispensed-fluid-sensor the volume of deicing fluid dispensed from the deicing vehicle onto the designated exterior portion by the operator, wherein the designated exterior portion comprises at least one aircraft section;
retrieving from an aircraft database the surface area of each aircraft section included in the designated exterior portion, wherein the aircraft database stores the surface area of each aircraft section associated with the aircraft;
calculating using a computer processor the surface area of the designated exterior portion based upon the surface area of each aircraft section included in the designated exterior portion;
determining an operator-efficiency-rating based at least in part on the ratio of the volume of dispensed deicing fluid to the surface area of the designated exterior portion.

9. The computer-enabled method of claim 8, comprising:
receiving via an input device a user's identification of the aircraft section(s) included in the designated exterior portion.

10. The computer-enabled method of claim 9, comprising:
receiving via an input device a user's identification of the operator who dispersed the deicing fluid onto the designated exterior portion;
associating the operator with the operator-efficiency-rating.

11. The computer-enabled method of claim 8, wherein the deicing fluid comprises a deicing component and an anti-icing component.

12. The computer-enabled method of claim 8, wherein the aircraft database stores the surface area of each of the following aircraft sections: a left wing portion and a right wing portion.

13. The computer-enabled method of claim 8, wherein the aircraft database stores the surface area of each of the following aircraft sections: a left horizontal stabilizer portion and a right horizontal stabilizer portion.

14. The computer-enabled method of claim 8, wherein the aircraft database stores the surface area of each of the following aircraft sections: a left fuselage side portion and a right fuselage side portion.

15. A non-transitory computer-readable storage medium storing computer-readable program code, wherein, when executed by a computer processor, the computer-readable program code:
receives from a dispensed-fluid-sensor the volume of deicing fluid dispensed from a deicing vehicle onto an aircraft's designated exterior portion by an operator;
retrieves from an aircraft database the surface area of each aircraft section included in the designated exterior portion, wherein the aircraft database stores the surface area of each aircraft section associated with the aircraft;
calculates the surface area of the designated exterior portion based upon the surface area of each aircraft section included in the designated exterior portion;
determines an operator-efficiency-rating based at least in part on the ratio of the volume of dispensed deicing fluid to the surface area of the designated exterior portion.

16. The non-transitory computer-readable storage medium of claim 15, wherein, when executed by the computer processor, the computer-readable program code:
receives from an input device a user's identification of the aircraft section(s) included in the designated exterior portion.

17. The non-transitory computer-readable storage medium of claim 16, wherein, when executed by the computer processor, the computer-readable program code:
receives from an input device a user's identification of the operator who dispersed the deicing fluid onto the designated exterior portion;
associates the operator with the operator-efficiency-rating.

18. The non-transitory computer-readable storage medium of claim 5, wherein the deicing fluid comprises a deicing component and an anti-icing component.

19. The non-transitory computer-readable storage medium of claim 17, wherein the aircraft database stores the surface area of each of the following aircraft sections: a left wing portion, a right wing portion, a left horizontal stabilizer portion, a right horizontal stabilizer portion, a left fuselage side portion, and a right fuselage side portion.

20. The non-transitory computer-readable storage medium of claim 17, wherein the operator-efficiency rating is determined by an evaluation of one or more of the following variables: the ratio of the volume of deicing fluid dispersed to the surface area of the designated exterior portion, the time to completion of the deicing job, and the number of deicing jobs completed per unit of time.
